(19) United States
(12) Patent Application Publication
(10) Pub. No.: US 2013/0076992 A1
(43) Pub. Date: Mar. 28, 2013

(54) VIDEO DISPLAY APPARATUS

(71) Applicants: Fumio HARUNA, Fujisawa (JP); Michio Hatagi, Chigasaki (JP)

(72) Inventors: Fumio HARUNA, Fujisawa (JP); Michio Hatagi, Chigasaki (JP)

(21) Appl. No.: 13/552,691

(22) Filed: Jul. 19, 2012

(30) Foreign Application Priority Data
Sep. 26, 2011 (JP) 2011-208410

(51) Int. Cl. H04N 5/66

(52) U.S. Cl. 348/739; 348/E05.133

(57) ABSTRACT

A video display apparatus includes plural light sources, plural light source driving portions configured to drive the plural light sources, a reflection mirror configured to reflect and project a light emitted from the light sources onto an object, a mirror driver portion configured to drive the reflection mirror, and a video processor portion configured to conduct signal processing on an input video signal. The lights of the light sources are incident upon the reflection mirror along differing axes so as to be projected onto differing areas and are combined so as to display a picture of an input video signal. The video processor portion effects control so that that a picture corresponding to a region where plural projection pictures optically overlap, is made up with the light emitted from one of the light sources, thereby reducing deterioration of picture quality.

This application relates to and claims priority from Japanese Patent Application No. 2011-208410 filed on Sep. 26, 2011, the entire disclosure of which is incorporated herein by reference.

### BACKGROUND OF THE INVENTION

The present invention relates to a video display apparatus applying therein, MEMS (Micro Electro Mechanical System), etc.

In recent years, a small-size projector with applying MEMS and a semiconductor laser light source is spreading, widely. For example, in the following Patent Document 1 is described a projector for projecting a picture, by scanning a MEMS mirror having two (2) axes in the horizontal and the vertical directions, while modulating a laser light source at the same time.

However, since a semiconductor laser light to be applied into the small-size projector for the time being is still low, there is a problem that a screen, which can be obtained through displaying, is dark. For this reason, in the following Patent Document 2 is disclosed a method for compensating shortage of an amount of lights, with driving plural numbers of small-size projectors in parallel with.

Also, in the following Patent Document 3 is disclosed a technology for scanning laser lights of two (2) sets of laser light sources by only one (1) of a MEMS mirror, and in more details thereof, there is disclosed a technology of dividing the two (2) sets of the laser light sources into the left and the right in the horizontal direction, so as to conduct the scanning in engagement with vibration of the MEMS mirror in the horizontal direction.

### PRIOR ART DOCUMENTS

### Patent Documents

[Patent Document 1] Japanese Patent Laying-Open No. 2006-343397 (2006);

[Patent Document 2] Japanese Patent Laying-Open No. 2009-15125 (2009); and

[Patent Document 3] Japanese Patent Laying-Open No. 2008-32895 (2008).

### BRIEF SUMMARY OF THE INVENTION

However, with the technology disclosed in the Patent Document 2, since two (2) sets of separate projection units are driven in parallel with, therefore it has a problem of high costs.

Also, with the technology disclosed in the Patent Document 2, it merely discloses only that for controlling the brightness of the pictures projected, in regions thereof filling up each other, so as to bring boundaries between the projection regions to be hard to see; however, no consideration was paid on a projection distortion in the projection regions.

With the technology disclosed in the Patent Document 3, it never pay the consideration upon an improvement of the brightness on the screen displayed.

An object of the present invention lies to provide a laser projector, for achieving an improvement of brightness on the screen to be displayed, and also for enabling to correct a two-dimensional distortion on the screen to be displayed, which is caused due to an accuracy of scanning by means of the MEMS mirror and/or an accuracy of a laser optic unit.

According to the present invention, for dissolving the problem(s) mentioned above, there is provided a video display apparatus, comprising: plural numbers of light sources; plural numbers of light source driving portions, which are configured to drive said plural numbers of light sources; a reflection mirror, which is configured to reflect a light emitting from said light sources, thereby projecting it onto an object; a mirror driver portion, which is configured to drive said reflection mirror; and a video processor portion, which is configured to conduct signal processing on an input video signal, wherein the lights of said plural numbers of light sources are incident upon said reflection mirror along with axes differing from, so as to be projected onto projection areas differing from, and those are combined with, and thereby displaying a picture of one of input video signal, and said video processor portion makes such a control that a picture corresponding to a region, where plural numbers of projection pictures optically overlap, is made up with the light emitting from one of said light sources.

According to the present invention mentioned above, it is possible to provide a laser projector having high brightness on the screen displayed and having no distortion on the picture.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a view for showing the basic configuration of a video display apparatus 1, according to an embodiment of the present invention;

FIG. 2 is a view for showing an internal configuration of an optic means 5 of the present embodiment;

FIG. 3A is a view for showing an example of shifting of a picture displayed;

FIG. 3B is a view for showing other example of shifting of the picture displayed;

FIG. 4A is a view for showing an example of superimposing of pictures;

FIG. 4B is a view for showing other example of superimposing of pictures;

FIG. 5 is a view for showing an operation of superimposing in the present embodiment;

FIG. 6 is a view for showing an internal configuration of a video processor portion 2 of the present embodiment;

FIG. 7 is a view for showing an operation of the video processor portion 2 of the present embodiment;

FIG. 8 is a view for showing an operation of superimposing in the present embodiment;

FIG. 9 is a view for showing an operation of the video processor portion 2 of the present embodiment; and

FIG. 10 is a view for showing an operation of the video processor portion 2 of the present embodiment.

### DETAILED DESCRIPTION OF THE PREFERRED EMBODIMENTS

Hereinafter, embodiments according to the present invention will be fully explained by referring to the attached drawings. However, within all of the drawings for explaining the embodiments, principally, the same reference numeral is given to the same portion, respectively, and repetition of the explanation thereof will be omitted.

### Embodiment 1

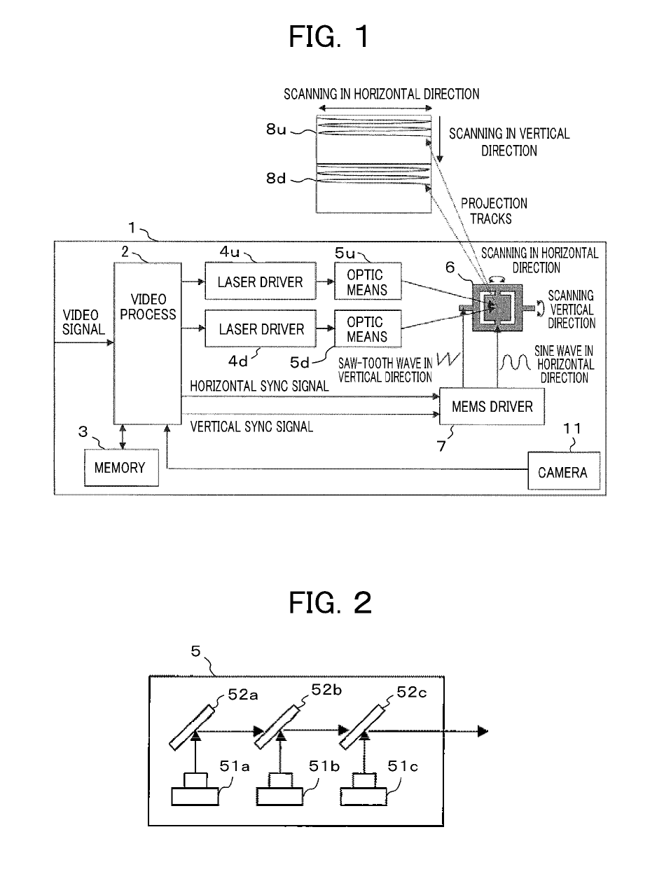

An example of a general internal configuration of a projection-type projector 1, applying MEMS therein, is shown in FIG. 1. The projection-type projector 1 is built up with a MEMS 6, laser drivers 4u and 4d, a MEMS driver 7, a video processor portion 2, a memory 3, optic means 5u and 5d, and a camera 11. The video processor portion 2 produces a video signal by adding various kinds of corrections onto a picture signal, which is inputted from an outside, and also produces a horizontal synchronization (sync) signal and a veridical synchronization (sync) signal in synchronism with that.

Herein, the various kinds of corrections means to conduct correction of picture distortion caused due to scanning of the MEMS 6, the details of which will be mentioned later, and/or to conduct corrections or the like in parallel processing, which will be mentioned later. In more details, the picture distortion is generated due to diversion of a facing angle between the projection-type projector 1 and a projection surface, and/or due to shift of the optical axes between the optic means 4u and 4d and the MEMS 6. An amount or volume of this picture distortion is obtained through measurement of the facing angle between the projection surface by means of the camera 11 and calculation of the amount of the picture distortion, etc. The laser drivers 4u and 4d receive the video signal, which is outputted from the video processor portion 2, and modulate a laser 51 within the optic means 5u and 5d, which will be mentioned later, depending on that.

FIG. 2 shows the details of the configuration of the optic means 5u and 5d. Each of the optic means 5u and 5d is constructed with the laser 51 and a reflection mirror 52, respectively. As the laser 51 are applied three (3) pieces of lasers (51a, 51b and 51c) for R, G and B, for example, and they are modulated for each of R, G and B of the video signal; i.e., laser beams of R, G and B are outputted. The laser beams of R, G and B are composed by means of the reflection mirror 52. The reflection mirror applies therein a special optical element, such as, that for reflecting a specific wavelength(s) thereon, but passing through wavelengths other than that, for example, and it is called a “dichroic mirror”, in general.

For example, the reflection mirror 52a has characteristics of reflecting all of the laser beams thereon, the reflection mirror 52b has that of reflecting the laser beam of the laser 51b while passing the laser beam of the laser 51a therethrough, and the reflection mirror 51c has that of reflecting the laser beam of the laser 51c while passing the laser beams of the lasers 51a and 51b. With this, it is possible to compose the laser beams of R, G and B into a one (1) piece thereof.

Turning back to FIG. 1, the laser beam composed by the optic means 5 enters into the MEMS 6. The MEMS 6 has a rotation mechanism of 2-axes for one element thereof, and therefore a mirror portion at the center thereof can be vibrated in the horizontal direction and the vertical direction through those 2-axes. Control of vibration of the mirror is carried out by the MEMS driver 7.

Herein, there are provided two (2) systems, each having the laser driver 4 and the optic means 5, and they are driven in a combination, i.e., the laser driver 4u and the optic means 5u, and the laser driver 4d and the optic means 5d, wherein the optic means 5u and the optic means 5d are disposed up and down, in the vertical direction, along a rotation axis of the MEMS mirror in the horizontal direction. And, when two (2) pieces of the laser beams enter into the MEMS 6, they are incident upon a one (1) point at the center of the MEMS mirror (the position corresponding to an intersection point of the rotation axes of the 2-axes vibration mechanism), at a predetermined angle.

The MEMS driver 7 produces a sinusoidal wave in synchronism with the horizontal sync signal from the video processor portion 2, and also produces a saw-tooth wave in synchronism with the vertical sync signal; thereby driving the MEMS 6. The MEMS 6 receives the above-mentioned sinusoidal wave to conduct a sine wave movement in the horizontal direction, and at the same time, it receives the above-mentioned saw-tooth wave to conduct a uniform motion into one (1) direction in the vertical direction. With this, the laser beams are scanned on the tracks as shown by 8u and 8d in FIG. 1, and synchronization of that scanning with a modulating operation by means of the laser driver 4 brings about projection of an input video.

Herein, the laser beams, which are modulated by the laser driver 4u and the optic means 5u, form a picture 8u in an upper portion of the video, and the laser beams, which are modulated by the laser driver 4d and the optic means 5d, form a picture 8d in a lower portion of the video, and thereby forming a one (1) piece of picture.

Thus, within the projection-type projector 1, according to the present embodiment, a one (1) piece of picture is formed with scanning in the horizontal direction by two (2) pieces of laser beams, i.e., scanning the upper and the lower portions of a frame screen by the laser beams differing from each other. For this reason, the time for scanning a frame of one (1) piece of picture is short, and since it is possible to increase the frame frequency, therefore it is possible to increase the display brightness.

Because scanning is conducted by the two (2) sets of the lasers in the horizontal direction, the video processor portion 2 divides the video signal into two (2) lines, i.e., an upper one and a lower one, so as to carry out the processing, with using the memory 2, and also carries out an interpolation process on a piling-up portion between the upper one and the lower one.

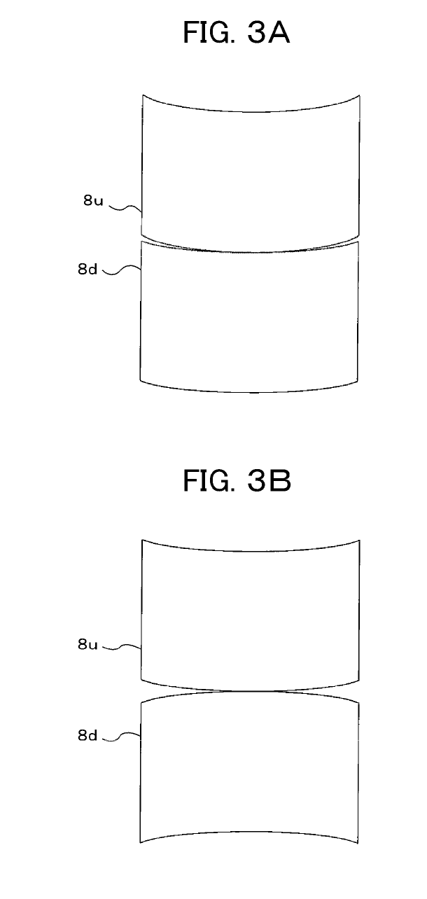

Next, detailed explanation will be given in relation to the scanning of the laser beams for the pictures 8u and 8d shown in FIG. 1. FIGS. 3A and 3B are views for showing an example of the picture scanned by the laser beams of the optic means 5u and 5d. When the laser beams are scanned made by means of the MEMS 6, a picture projected does not always becomes a correct rectangular, and there are cases where peripheral portions thereof are distorted. The reason of this lies in that, as was mentioned previously, the projection-type projector 1 and the projection surface differ from in the facing angle therebetween, or due to the shifting of the optical axes between the optic means 5u and 5d and the MEMS 6 (the position and the angle).

In case of this, the optical axes of the two (2) pieces of laser beams from the optic means 5u and 5d are adjusted, i.e., conducting the position correction on the scanning surface, so that an upper-end scanning line of the scanning picture 8u and a lower-end scanning line of the scanning picture 8d are in contact with each other; however, as is shown in FIGS. 3A and 3B, there may be occurs a case where they are not in contact with in the horizontal direction. For example, as is shown in FIGS. 3A and 3B, there are cases where they are in contact with in the horizontal direction at a central portion thereof, but are separated at both ends thereof. In other words, the picture is preferable in continuity at the central portion of the picture, but is lost in part thereof one the both ends due to the picture distortion; and this brings about an inferior picture quality. However, those shown in FIGS. 3A and 3B are made upon an assumption that the manners of the picture distortions are different from, between the upper portion and the lower portion of the screen; however, anyway, the lost of the picture generates.

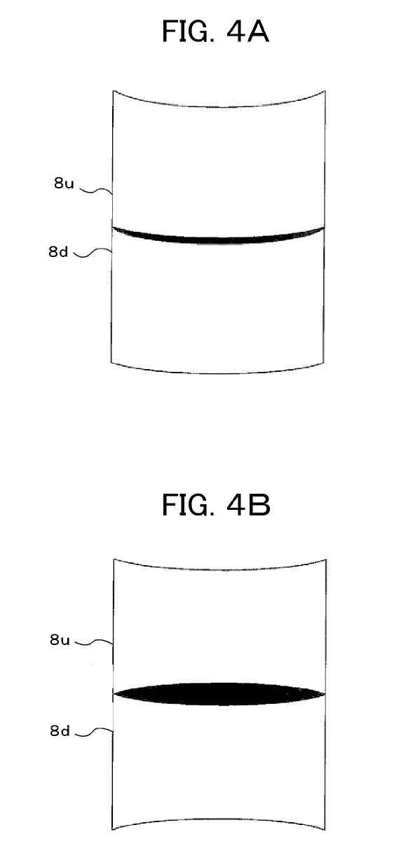

FIGS. 4A and 4B show examples when the correction is made on the angles of two (2) pieces of the laser beams from the optic means 5u and 5d, respectively, which are entered or incident upon the MEMS 6 to be coincident with between the upper and the lower portions on the both ends of the screen. In this case, at the central portion of the screen, the scanning beams of the upper and the lower portions overlap with each other, and thereby becoming a plural number of lines (see a hutched portion in FIGS. 4A and 4B).

In such case, by lowering a (brightness) level down to a half (½) thereof, respectively, through the signal processing, in relation to the portion where the upper and the lower portions overlap with each other at the central portion on the screen, with applying the technology disclosed in the Patent Document 1 mentioned above, it is possible to bring them unrecognizable; however, since that is the portion where the scanning lines come cross each other, obliquely, up and down, it is impossible to make the compensation thereof, completely, i.e., the portion where they overlap at the center can be recognized to be the difference of light and shade of brightness and resolution, comparing to other portions on the screen.

Then, according to the present embodiment, a distortion compensation is conducted on the scanning picture, while controlling the scanning of the upper and the lower screens, as will be mentioned hereinafter.

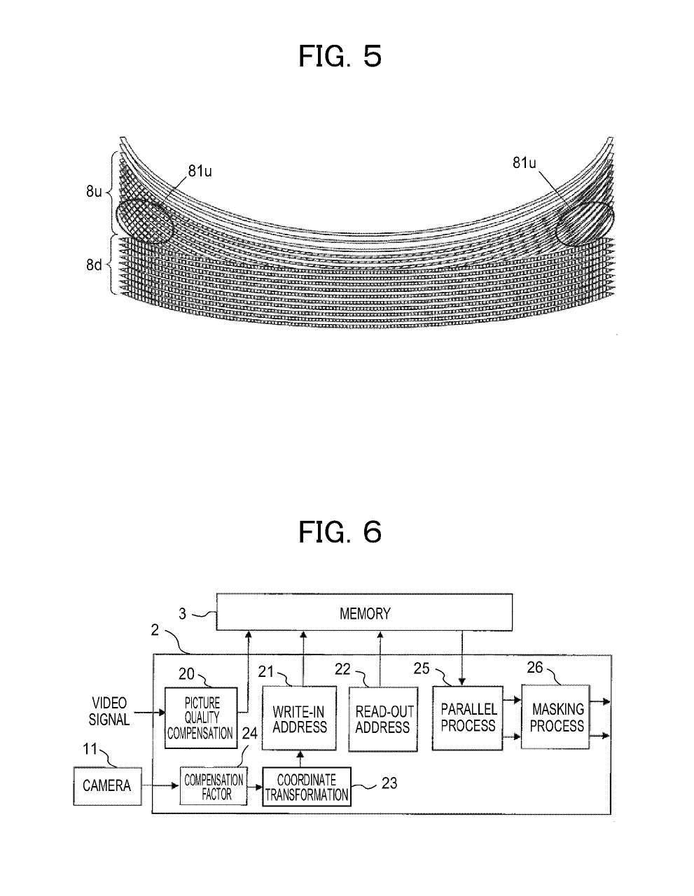

FIG. 5 shows the details of a beam scanning line, in case where the angles of the two (2) pieces of laser beams from the optic means 5u and 5d are adjusted so that they are coincident with up and down on the both ends of the screen shown in FIG. 4A. In the present embodiment, not interpolation of the portion, where the beam scanning lines overlap with each other at the center of the screen, with the beam scanning up and down, but the display is conducted by making the beam scanning on one of the screens. Thus, the video processor portion 2 control the laser driver 4u, in such a manner that a light emission is stopped at the position, where they overlap with, on the beam scanning of the picture 8u, but is made only in a gap region 81u on both ends of the screen.

FIG. 6 is a view for showing an internal configuration of the video processor portion 2, and FIG. 7 is a mapping view of the picture 8u on the memory 3, which is processed in the video processor portion 2. This is, for example, a picture map of N pieces of horizontal pixels and M pieces of vertical pixels. Hereinafter, explanation will be given on processing within the video processor portion 2.

The video processor portion 2, first of all, conducts general processing for compensating the picture quality, such as, a contrast adjustment and a γ correction, etc., by means of a picture quality compensating portion 20, and a result thereof is stored in the memory 3. When the video data compensated is written into the memory 3, it is written at memory coordinates corresponding to an address, which is produced by a write-in address portion 21. The memory coordinates are calculated by a coordinate transformation portion 23.

In the coordinate transformation portion 23, for compensating the video distortion caused due to scanning by the MEMS 6, transformation is conducted on the display picture of the video signal, which is inputted into the video processor portion 2, by means of an inverse transformation function of the picture transformation corresponding to the picture distortion, and thereby the video data is stored into the memory 3. For example, the coordinate transformation is made in such a manner that, a hatched line comes to be a straight vertical line or a straight horizontal line without distortion when displaying a cross-hatch screen.

In more details thereof, since an amount or volume of the video distortion of a keystone distortion differs from depending on the facing angle between the projection-type projector 1 and the projection surface, as was mentioned before, the facing angle between the projection surface is measured by the camera 11, and the value thereof is inputted into a compensation factor portion 24. The compensation factor portion 24, being able to calculate the amount or volume of the video distortion, to be determined depending on the facing angle between the projection-type projector 1 and the projection surface, in the form of a function value, produces such a compensation factor that the volume of the video distortion can be changed fitting to the facing angle, and inputs it to the coordinate transformation portion 23. The coordinate transformation portion 23 adjusts the coordinate value of the video signal fitting to this compensation factor.

Also, as is shown in FIGS. 3A and 3B, in case where the upper and the lower scanning pictures are different from, in the volume of the distortion thereof, a previous cross-hatch screen is displayed as an input video, and the display picture is picked up by the camera 11, so as to obtain the two-dimensional picture distortion, and the inverse transformation is conducted. Detecting the volume of distortion in the form of a plane enables to compensate the display distortion even when displaying the picture on a screen having concave/convex thereon.

The video data after the coordinate transformation, which is stored in the memory 3, is read out in the order of the addresses designated by a readout address portion 22, corresponding to the mirror scanning. Since the coordinate transformation is already made on the video data within the memory 3, the readout address portion 22 produces such an address that the data is read out, successively, from a top of the memory 3, when being read out.

The video data, which is readout, is inputted into a parallel processor portion 25. The parallel processor portion 25 conducts a distribution process for dividing the data into two (2) lines, i.e., the laser drivers 4u and 4d.

A mask process portion 26, upon receipt of an output from the parallel processor portion 25, conducts a control upon a light emission of laser beam at the position, where the scanning beams overlap with each other. In more details thereof, in the beam scanning for making such a display as shown by 81u in FIG. 5, a masking process is conducted on output data, so that no light emission of laser beam is conducted at the position where a picture 8u overlaps on a picture 8d, each other.

As a result of conducting such processing as was mentioned above, the masking process is conducted on the data so that no light emission of laser beam is generated in a fan-shaped area or region of a gray-hatch in a lower portion of the screen, where the picture 8u overlaps on the picture 8d, as is shown in a mapping view shown in FIG. 7, while the light emission of laser beam is generated in an area or region, which is shaded by oblique lines, corresponding to the gap area or region 81u.

### Embodiment 2

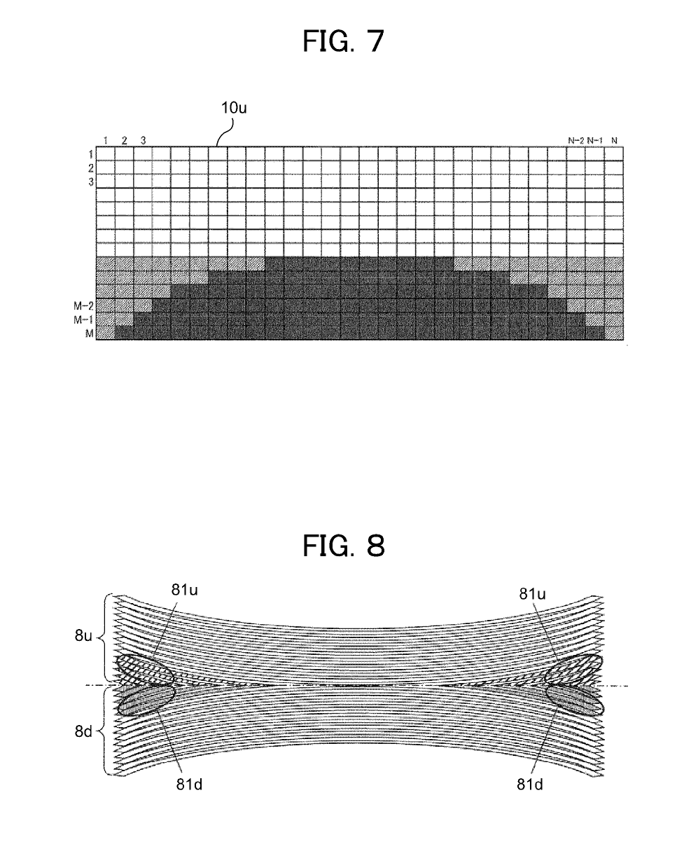

FIG. 8 is a view for explaining an embodiment 2, according to the present invention, and this is for explaining the control contents under the condition where the laser scanning beams overlaps, as is shown in FIG. 4B. Although the detailed explanation will be given hereinafter, the control under the piling-up condition shown in FIG. 4B should not be limited only to a control method, which will be mentioned hereinafter, but there are other methods for sharing.

The entire structures or configuration of the video processor portion 2 are similar to those of the previous embodiment, and therefore the explanation thereof will be omitted herein; however, this differs from the previous embodiment in an aspect that the scanning is made on the area or region where the laser scanning beams overlap with each other, as shown in FIG. 4B, by the optic means 5u and 5d, being provided up and down.

As is shown in FIG. 8, the laser scanning beams corresponding to the pictures 8u and 8d are scanned, symmetrically, up and down. Accordingly, it is enough to conduct the processing on the picture 8u in the similar manner to that of the picture 8d.

On the beam scanning of the picture 8d, light emission is made at the position 81d shown in FIG. 8, but the light emission is stopped where the picture 8d and the picture 8u overlap on each other; i.e., the video processor portion 2 controls the laser driver 4d so that the light emission is made in the gap area or region 81d on both ends of the screen.

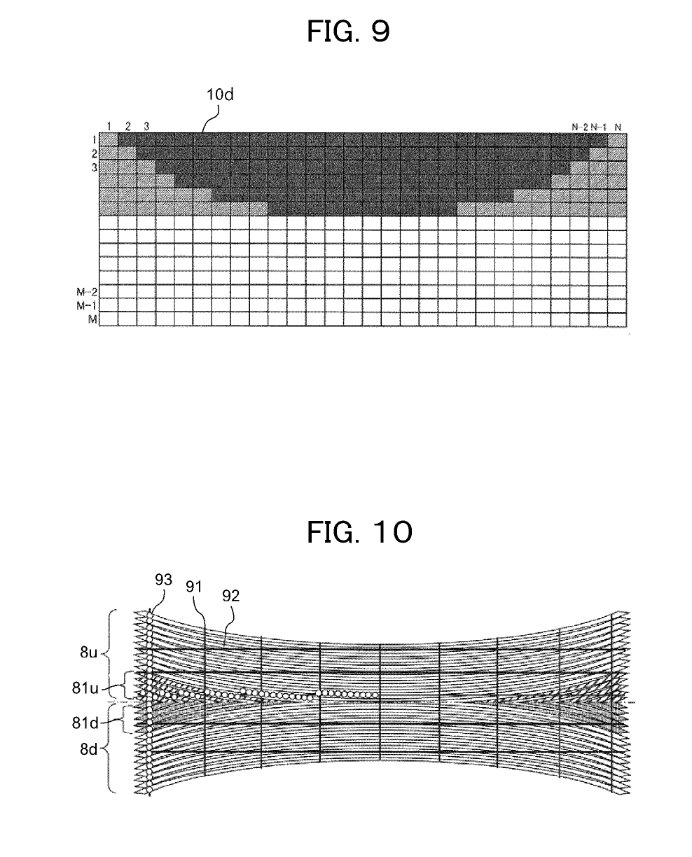

FIG. 9 is a mapping view 10d of the picture 8d within the video processor portion 2, wherein it is a video map having N pieces pixels in the horizontal direction and M pieces pixels in the vertical direction, for example. In the fan-shaped portion of gray-hatch in an upper portion on the screen, where the picture 8d overlaps on the picture 8u, as shown in FIG. 9, the masking process is conducted, i.e., turning the video into a black display, not to emit the light therefrom. And, in the area or region shaded by oblique lines, corresponding to the gap area or region 81d, the light emission is made. Since the operation within the video processor portion 2 is similar to that shown in FIG. 7, the explanation thereof will be omitted herein.

FIG. 10 is a view for showing an example of the light emission when displaying the cross-hatch screen upon an assumption of FIG. 8, and wherein there are displayed a cross-hatch vertical line 91 and a part of a light emitting point 93, when wishing to display a cross-hatch horizontal line 92. In this manner, by conducting the mapping process for compensating the picture distortion, in the gap areas or regions 81u and 81d, within the video processor portion 2, similar to that for other area(s) or region(s), it is possible to conduct a normal video display without distortion, even when displaying the cross-hatch screen.

However, in the present embodiment, although the example is shown therein, combining two (2) pieces of the laser lights; however, the present invention is applicable into a case of combining three (3) or more numbers of the laser lights. Also, thought the camera 11 is applied for measuring the facing angle defined between the projection-type projector 1 and the projection surface; however, the present invention should not be restricted only to this, and if it is sufficient to detect only an inclination of the projection-type projector 1, it may be an inclination sensor or a gravity sensor in the place thereof.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A video display apparatus, comprising:
plural numbers of light sources;
plural numbers of light source driving portions, which are configured to drive said plural numbers of light sources;
a reflection mirror, which is configured to reflect a light emitting from said light sources, thereby projecting it onto an object;
a mirror driver portion, which is configured to drive said reflection mirror; and
a video processor portion, which is configured to conduct signal processing on an input video signal, wherein
the lights of said plural numbers of light sources are incident upon said reflection mirror along with axes differing from, so as to be projected onto projection areas differing from, and those are combined with, and thereby displaying a picture of one of input video signal, and
said video processor portion makes such a control that a picture corresponding to a region, where plural numbers of projection pictures optically overlap, is made up with the light emitting from one of said light sources.

2. The video display apparatus, as is described in the claim 1, said video processor portion makes such a control that one of said light sources emits the light while other light source does not emit the light, in said area, so that the picture corresponding to the region, where the plural numbers of projection pictures optically overlap with, is made up with the light emitting from the one of said light sources.

3. The video display apparatus, as is described in the claim 1, said video processor portion makes such a control that one of said light sources emits the light while other light source does not emit the light, in said area, so that the picture corresponding to the region, where the plural numbers of projection pictures optically overlap with, is made up with the light emitting from the one of said light sources, and conducts a distortion compensation process so that a desired picture is displayed in said area.

4. A video display apparatus, comprising:
a first laser optic portion, which is configured to irradiate an upper-side picture of a picture to be displayed;
a second laser optic portion, which is configured to irradiate a lower-side picture of the picture to be displayed;
a reflection mirror, which is configured to make a beam light of said first laser optic portion and a beam light of said second laser optic portion scanning two-dimensionally;
a distortion detect portion, which is configured to detect an amount of irradiation distortion on a displayed picture; and
a video processor portion having a coordinate transforming portion, which is configured to transform a display position of video information upon basis of the amount of irradiation distortion detected by said distortion detect portion, and a masking process portion, which is configured to control a light emission of laser beam in an area where a beam scanning line due to said first laser optic portion and a beam scanning line due to said second laser optic portion overlap on each other, wherein
said first laser optic portion and said second laser optic portion emit the laser beams upon basis of the video information, which is processed by said video processor portion.

5. The video display apparatus, as described in the claim 4, wherein
said first laser optic portion and said second laser optic portion are provide along with a rotation axis of said reflection mirror in the scanning thereof in the horizontal direction, in such a manner that the optical axis of the beam directs to a rotation center of said reflection mirror.
